(19) United States
(12) Patent Application Publication
(10) Pub. No.: US 2015/0028752 A1
(43) Pub. Date: Jan. 29, 2015

(54) CONTROL CIRCUIT OF LIGHT EMITTING DIODES AND OPERATION METHOD OF A CONTROL CIRCUIT OF LIGHT EMITTING DIODES

(71) Applicant: Leadtrend Technology Corp., Hsin-Chu (TW)

(72) Inventors: Yeu-Torng Yau, Hsin-Chu (TW); Wei-Chi Huang, Hsin-Chu (TW); Hung-Ching Lee, Hsin-Chu (TW); Chung-Wei Lin, Hsin-Chu (TW); Wei-Wen Ou, Hsin-Chu (TW)

(21) Appl. No.: 14/335,963

(22) Filed: Jul. 21, 2014

(30) Foreign Application Priority Data
Jul. 23, 2013 (TW) 102126343

(51) Int. Cl. H05B 33/08

(52) U.S. Cl. CPC H05B 33/0815; H05B 33/0821
USPC 315/185 R

(57) ABSTRACT

A control circuit of light emitting diodes is used for driving at least one series of light emitting diodes. The control circuit includes a current setting pin, a driving current generator, a regulator circuit, and an adjuster. A reference current flows through the current setting pin. The driving current generator is used for generating a driving current flowing through the series of light emitting diodes according to the reference current. The adjuster generates an adjustment voltage according to the reference current. Then, the regulator circuit generates a supply voltage to drive the series of light emitting diodes, and regulates a voltage of a first terminal of the series of light emitting diodes at a target voltage according to the adjustment voltage. The target voltage is increased with decrease of the driving current when the driving current is less than a first predetermined current.

### BACKGROUND OF THE INVENTION

1. Field of the Invention

The present invention relates to a control circuit of light emitting diodes and an operation method of a control circuit of light emitting diodes, and particularly to a control circuit of light emitting diodes and an operation method of a control circuit of light emitting diodes that can utilize an adjuster and a regulator circuit to generate a target voltage which is dynamically changed with a driving current according to a reference current.

2. Description of the Prior Art

After a control circuit of light emitting diodes provided by the prior art utilizes a reference voltage generation circuit to generate a reference voltage, the reference voltage can control a voltage of a first terminal of a series of light emitting diodes to let the voltage of the first terminal of the series of light emitting diodes be fixed at a target voltage through a closed loop formed by a boost converter, wherein a function of the target voltage is used for letting a circuit which provides a driving current to the series of light emitting diodes operate normally.

However, the target voltage cannot be changed after the control circuit sets the target voltage, that is to say, the target voltage cannot be changed with the driving current for driving the series of light emitting diodes when a user adjusts the driving current. Therefore, if the target voltage is too high, the control circuit will waste much power to have lower power efficiency; and if the target voltage is too low, the control circuit cannot work normally.

### SUMMARY OF THE INVENTION

An embodiment provides a control circuit of light emitting diodes, wherein the control circuit is used for driving at least one series of light emitting diodes. The control circuit includes a current setting pin, a driving current generator, a regulator circuit, and an adjuster. A reference current flows through the current setting pin. The driving current generator is used for generating a driving current flowing through the series of light emitting diodes according to the reference current. The adjuster is used for generating an adjustment voltage according to the reference current. The regulator circuit is used for regulating a voltage of a first terminal of the series of light emitting diodes at a target voltage and generating a supply voltage to drive the series of light emitting diodes according to the adjustment voltage. When the driving current is less than a first predetermined current, the target voltage is increased with decrease of the driving current.

Another embodiment provides an operation method of a control circuit of light emitting diodes, wherein the control circuit comprises a current setting pin, an adjuster, a regulator circuit, and a driving current generator, and the control circuit is used for driving at least one series of light emitting diodes. The operation method includes setting a reference current according to an external resister coupled to the current setting pin, wherein the reference current flows through the current setting pin; the driving current generator generating a driving current flowing through the series of light emitting diodes according to the reference current; the adjuster generating an adjustment voltage according to the reference current; and the regulator circuit regulating a voltage of a first terminal of the series of light emitting diodes at a target voltage and generating a supply voltage to drive the series of light emitting diodes according to the adjustment voltage, wherein when the driving current is less than a first predetermined current, the target voltage is increased with decrease of the driving current.

The present invention provides a control circuit of light emitting diodes and an operation method of a control circuit of light emitting diodes. The control circuit and the operation method utilize an adjuster generates an adjustment voltage changed with a driving current according to a reference current. Then, a regulator circuit can regulate a voltage of a first terminal of a series of light emitting diodes at a target voltage according to the adjustment voltage changed with the driving current. Therefore, when the driving current is greater than a predetermined current, the regulator circuit can control the target voltage to be increased with increase of the driving current, and when the driving current is less than the predetermined current, the regulator circuit can control the target voltage to be increased with decrease of the driving current. Thus, the present invention has advantages as follows: first, because when the driving current is less than the predetermined current, the target voltage is increased with decrease of the driving current, the present invention can reduce an error of the target voltage; second, because when the driving current is less than the predetermined current, the target voltage is increased with decrease of the driving current, the present invention not only can increase a signal-to-noise ratio of the target voltage, but can also overcome errors within the regulator circuit simultaneously; third, because when the driving current is less than the predetermined current, the target voltage is increased with decrease of the driving current, an offset of the driving current is decreased, resulting in accuracy of the driving current being higher; fourth, because the adjuster only increases a few elements to the control circuit, cost of the present invention is only little increased; and fifth, the present invention can increase power efficiency and decrease unnecessary heat.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a control circuit 100 of light emitting diodes according to an embodiment.

FIG. 2 is a diagram illustrating a relationship between the driving current and the target voltage.

FIG. 3 is a diagram illustrating the adjuster generating the adjustment voltage according to the first reference current.

FIG. 4 is a diagram illustrating a control circuit of light emitting diodes according to another embodiment.

FIG. 5 is a diagram illustrating an adjuster generating an adjustment voltage according to a first reference current.

FIG. 6 is a diagram illustrating a relationship between a driving current and a target voltage.

FIG. 7 is a diagram illustrating a control circuit of light emitting diodes according to another embodiment.

FIG. 8 is a diagram illustrating an adjuster generating an adjustment voltage according to a first reference current.

FIG. 9 is a diagram illustrating a relationship between a driving current and a target voltage.

FIG. 10 is a flowchart illustrating an operation method of a control circuit of light emitting diodes according to another embodiment.

FIG. 11 is a flowchart illustrating an operation method of a control circuit of light emitting diodes according to another embodiment.

FIG. 12 is a flowchart illustrating an operation method of a control circuit of light emitting diodes according to another embodiment.

### DETAILED DESCRIPTION

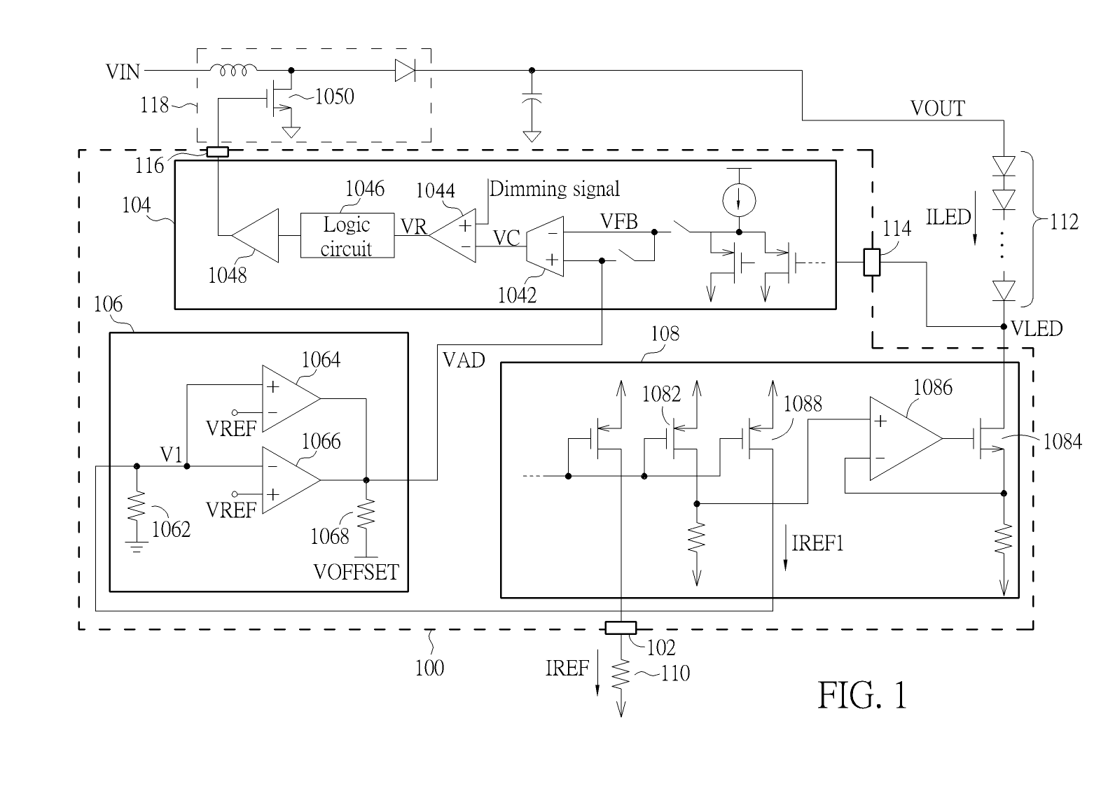

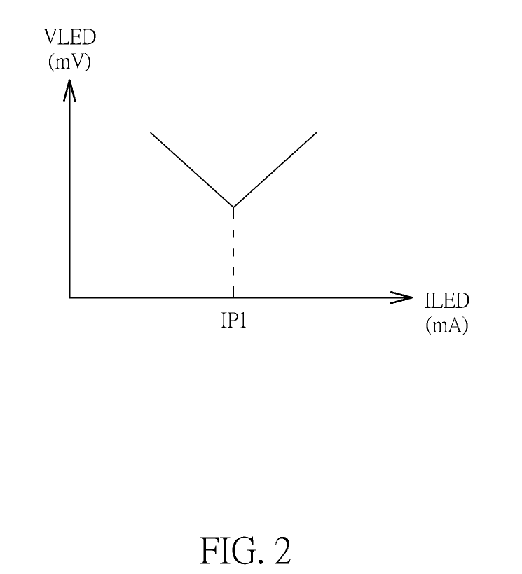

Please refer to FIG. 1. FIG. 1 is a diagram illustrating a control circuit 100 of light emitting diodes according to an embodiment. As shown in FIG. 1, the control circuit 100 includes a current setting pin 102, a regulator circuit 104, an adjuster 106, and a driving current generator 108. The current setting pin 102 is coupled to an external resister 110, wherein the current setting pin 102 is used for setting a reference current IREF through the external resister 110. The driving current generator 108 is coupled to a series of light emitting diodes 112, wherein the driving current generator 108 is used for generating a driving current ILED flowing through the series of light emitting diodes 112 according to the reference current IREF, transistors 1082, 1084, and an amplifier 1086. In addition, the driving current generator 108 is further used for adding a first reference current IREF1 proportion to the reference current IREF to the adjuster 106 through a transistor 1088 of the driving current generator 108. The adjuster 106 is coupled to the driving current generator 108, wherein the adjuster 106 is used for generating an adjustment voltage VAD changed with the driving current ILED according to the first reference current IREF1. The regulator circuit 104 is coupled to the adjuster 106. As shown in FIG. 1, a compensator 1042 of the regulator circuit 104 is used for generating a compensation value VC according to the adjustment voltage VAD and a feedback voltage VFB, wherein the feedback voltage VFB corresponds to a target voltage VLED, and the target voltage VLED is inputted to the regulator circuit 104 through a feedback pin 114. A comparator 1044 of the regulator circuit 104 is used for generating a comparison result VR according to the compensation value VC and a dimming signal. The comparison result VR is used for controlling a switch 1050 of a boost circuit 118 through a logic circuit 1046, a gate control circuit 1048, and a gate pin 116. Therefore, the regulator circuit 104 can regulate a voltage of a first terminal of the series of light emitting diodes 112 at the target voltage VLED and boost an input voltage VIN to generate a supply voltage VOUT to drive the series of light emitting diodes 112 through the above mentioned loop mechanism, wherein the target voltage VLED is equal to the supply voltage VOUT minus a voltage drop of the series of light emitting diodes 112. But, the present invention is not limited to the control circuit 100 only driving the series of light emitting diodes 112, that is to say, the control circuit 100 can drive more than one series of light emitting diodes. Please refer to FIG. 2. FIG. 2 is a diagram illustrating a relationship between the driving current ILED and the target voltage VLED. As shown in FIG. 2, when the driving current ILED is greater than a first predetermined current (e.g. 100 mA) IP1, the regulator circuit 104 can control the target voltage VLED to be increased with increase of the driving current ILED through the above mentioned loop mechanism, and when the driving current ILED is less than the first predetermined current IP1, the regulator circuit 104 can control the target voltage VLED to be increased with decrease of the driving current ILED through the above mentioned loop mechanism.

As shown in FIG. 1, the adjuster 106 includes a first resister 1062, a first operational transconductance amplifier (OTA) 1064, a second operational transconductance amplifier 1066, and a second resister 1068. The first resister 1062 is used for generating a first voltage V1 according to the first reference current IREF1. A positive input terminal and a negative input terminal of the first operational transconductance amplifier 1064 are coupled to the first resister 1062 and a reference voltage VREF respectively, wherein the reference voltage VREF corresponds to the first predetermined current IP1. A positive input terminal and a negative input terminal of the second operational transconductance amplifier 1066 are coupled to the reference voltage VREF and the first resister 1062. The second resister 1068 is coupled to the first operational transconductance amplifier 1064, the second operational transconductance amplifier 1066, and an offset voltage VOFFSET.

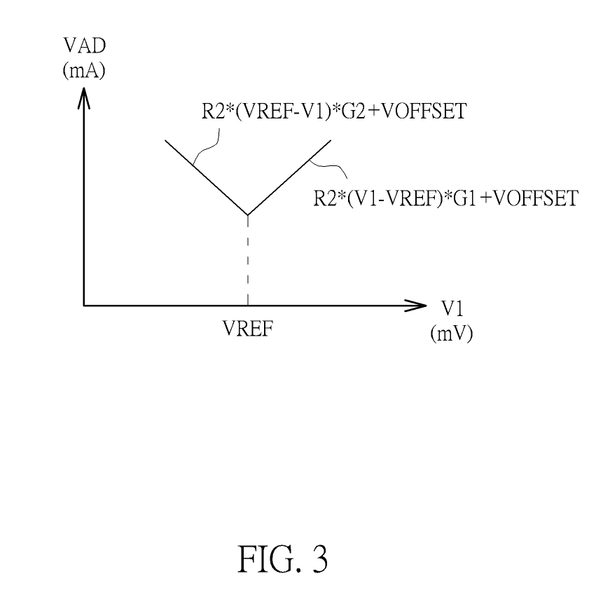

Please refer to FIG. 3. FIG. 3 is a diagram illustrating the adjuster 106 generating the adjustment voltage VAD according to the first reference current IREF1. As shown in FIG. 1 and FIG. 3, when the first voltage V1 is greater than the reference voltage VREF, the adjuster 106 generates the adjustment voltage VAD according to equation (1):

VAD=R2×(V1−VREF)×G1+VOFFSET (1)

As shown in equation (1), R2 is a resistance of the second resister 1068 and G1 is a transconductance of the first operational transconductance amplifier 1064.

As shown in FIG. 1 and FIG. 3, when the first voltage V1 is less than the reference voltage VREF, the adjuster 106 generates the adjustment voltage VAD according to equation (2):

VAD=R2×(VREF−V1) x×G2+VOFFSET (2)

As shown in equation (2), G2 is a transconductance of the second operational transconductance amplifier 1066. As shown in FIG. 1 and FIG. 3. Because the adjustment voltage VAD generated by the adjuster 106 is changed with the first voltage V1 (corresponding to the first reference current IREF1), the adjustment voltage VAD is changed with the driving current ILED (corresponding to the reference current IREF) . In addition, because the regulator circuit 104 can generate the supply voltage VOUT according to the adjustment voltage VAD, and the target voltage VLED is equal to the supply voltage VOUT minus the voltage drop of the series of light emitting diodes 112, the control circuit 100 can generate the target voltage VLED changed with the driving current ILED through the adjustment voltage VAD changed with the driving current ILED.

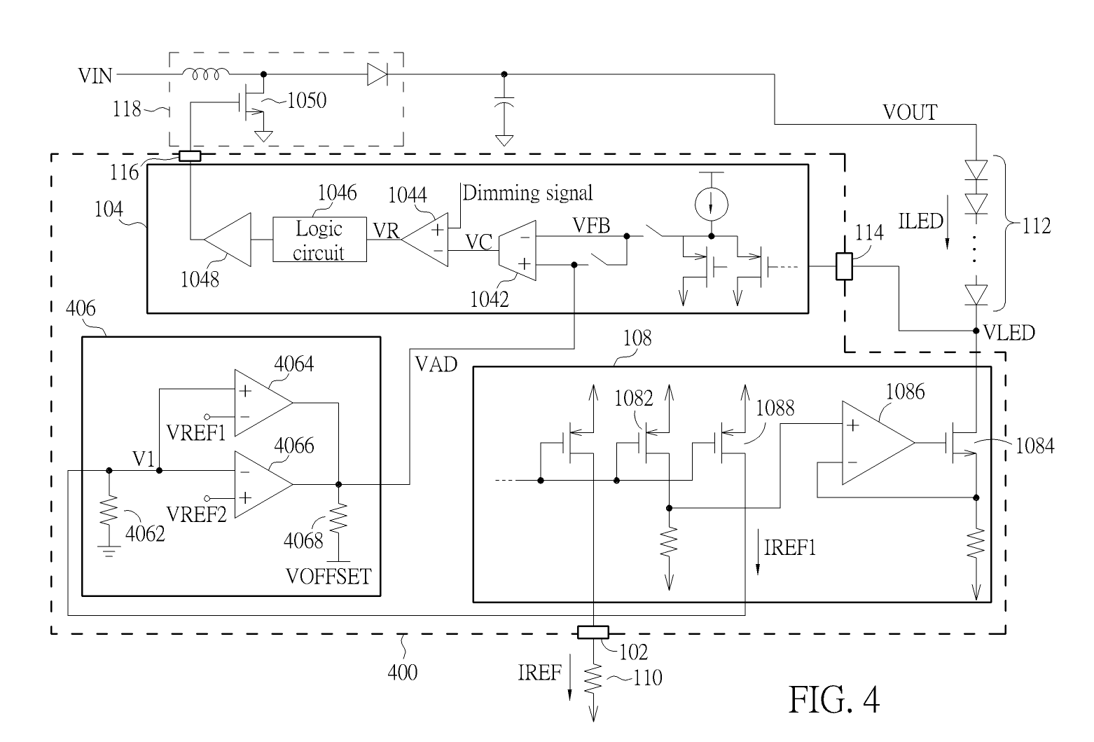

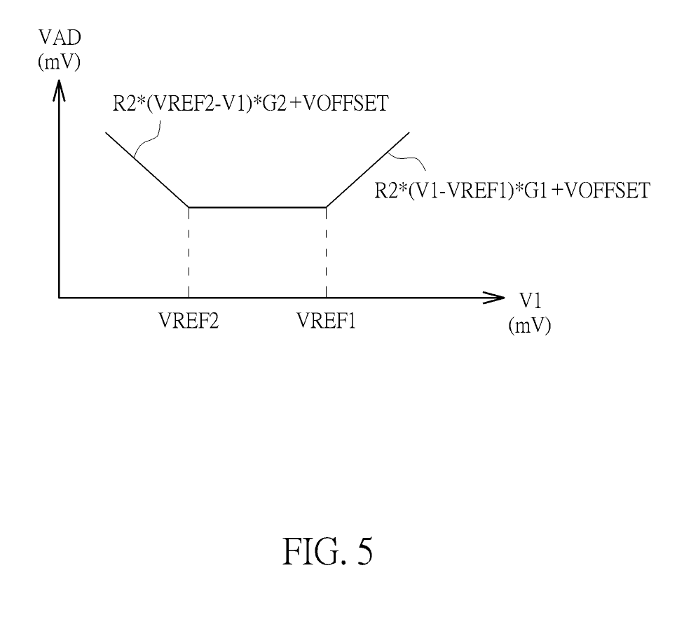

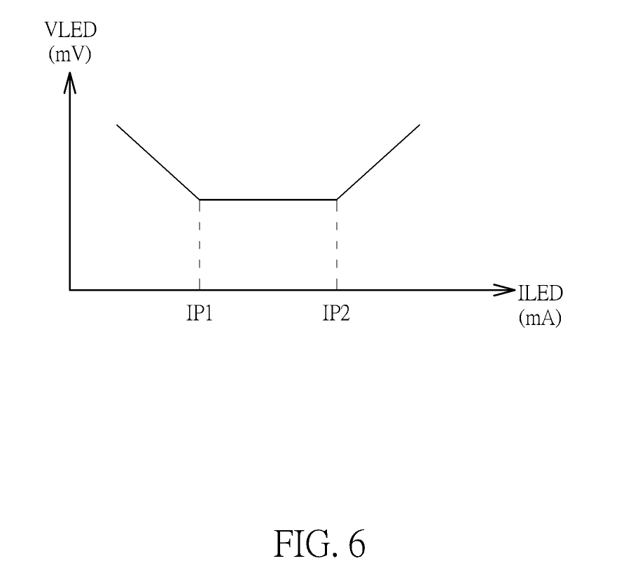

Please refer to FIG. 4, FIG. 5, and FIG. 6. FIG. 4 is a diagram illustrating a control circuit 400 of light emitting diodes according to another embodiment, FIG. 5 is a diagram illustrating an adjuster 406 generating an adjustment voltage VAD according to a first reference current IREF1, and FIG. 6 is a diagram illustrating a relationship between a driving current ILED and a target voltage VLED. As shown in FIG. 4, a difference between the control circuit 400 and the control circuit 100 is that the control circuit 400 includes the adjuster 406, wherein the adjuster 406 includes a first resister 4062, a first operational transconductance amplifier 4064, a second operational transconductance amplifier 4066, and a second resister 4068. The first resister 4062 is used for generating a first voltage V1 according to the first reference current IREF1. A positive input terminal and a negative input terminal of the first operational transconductance amplifier 4064 are coupled to the first resister 4062 and a first reference voltage VREF1, respectively, wherein the first reference voltage VREF1 corresponds to a second predetermined current IP2. A positive input terminal and a negative input terminal of the second operational transconductance amplifier 4066 are coupled to a second reference voltage VREF2 and the first resister 4062, respectively, wherein the second reference voltage VREF2 corresponds to a first predetermined current IP1. The second resister 4068 is coupled to the first operational transconductance amplifier 4064, the second operational transconductance amplifier 4066, and an offset voltage VOFFSET.

As shown in FIG. 4 and FIG. 5, when the first voltage V1 is greater than the first reference voltage VREF1, the adjuster 406 generates the adjustment voltage VAD according to equation (3):

VAD=R2×(V1−VREF1)×G1+VOFFSET (3)

As shown in equation (3), R2 is a resistance of the second resister 4068, and G1 is a transconductance of the first operational transconductance amplifier 4064.

As shown in FIG. 4 and FIG. 5, when the first voltage V1 is less than the second reference voltage VREF2, the adjuster 406 generates the adjustment voltage VAD according to equation (4):

VAD=R2×(VREF2−V1)×G2+VOFFSET (4)

As shown in equation (4), G2 is a transconductance of the second operational transconductance amplifier 4066. As shown in FIG. 4, FIG. 5, equation (3), and equation (4), when the first voltage V1 is between the first reference voltage VREF1 and the second reference voltage VREF2, the adjustment voltage VAD is equal to the offset voltage VOFFSET.

As shown in FIG. 4 and FIG. 5, because the adjustment voltage VAD generated by the adjuster 406 is changed with the first voltage V1 (corresponding to the first reference current IREF1), the adjustment voltage VAD is changed with the driving current ILED (corresponding to the reference current IREF). In addition, because the regulator circuit 104 can generate a supply voltage VOUT according to the adjustment voltage VAD, and the target voltage VLED is equal to the supply voltage VOUT minus a voltage drop of the series of light emitting diodes 112, the control circuit 400 can generate the target voltage VLED changed with the driving current ILED through the adjustment voltage VAD which is also changed with the driving current ILED. That is to say, as shown in FIG. 6, when the driving current ILED is greater than the second predetermined current IP2, the target voltage VLED is increased with increase of the driving current ILED; and when the driving current ILED is less than the first predetermined current IP1, the target voltage VLED is increased with decrease of the driving current ILED.

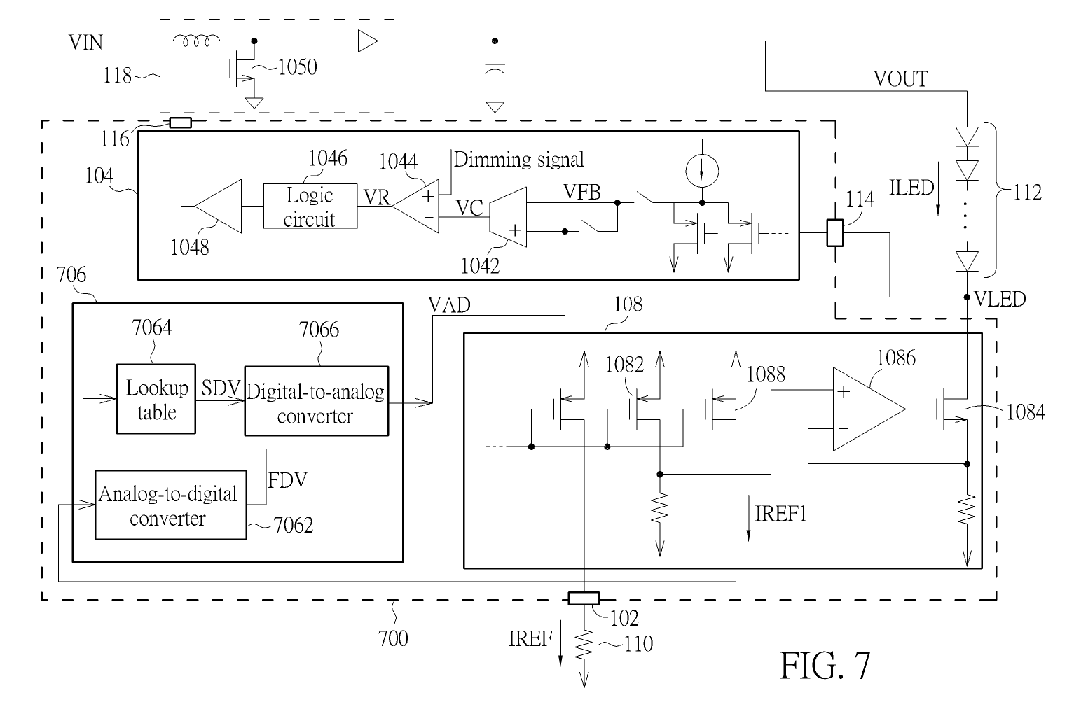

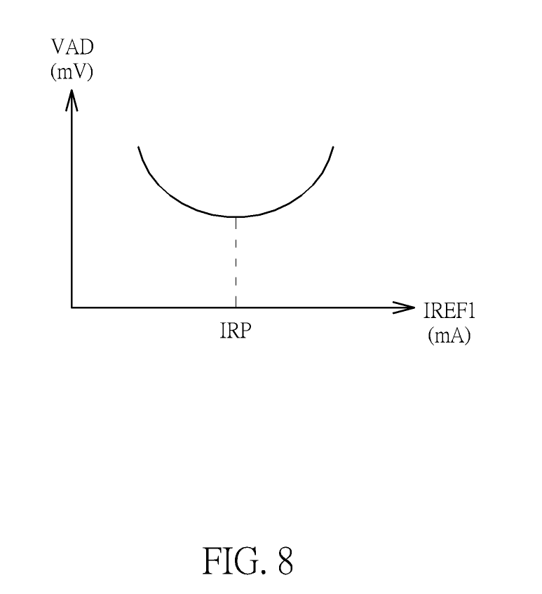

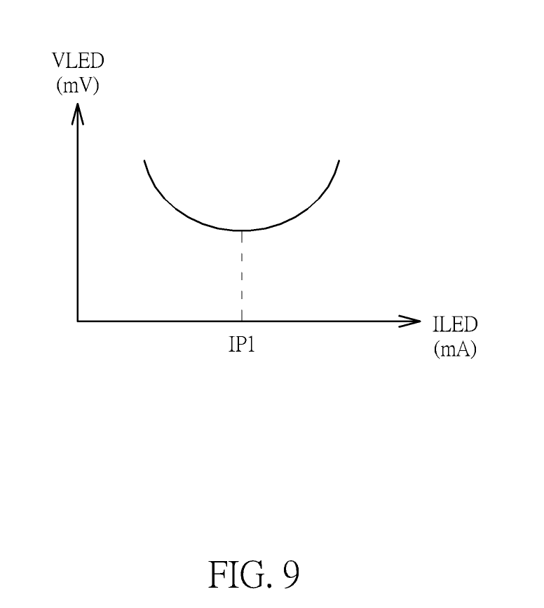

Please refer to FIG. 7, FIG. 8, and FIG. 9. FIG. 7 is a diagram illustrating a control circuit 700 of light emitting diodes according to another embodiment, FIG. 8 is a diagram illustrating an adjuster 706 generating an adjustment voltage VAD according to a first reference current IREF1, and FIG. 9 is a diagram illustrating a relationship between a driving current ILED and a target voltage VLED. As shown in FIG. 7, a difference between the control circuit 700 and the control circuit 100 is that the control circuit 700 includes the adjuster 706, wherein the adjuster 706 includes an analog-to-digital converter 7062, a lookup table 7064, and a digital-to-analog converter 7066. The analog-to-digital converter 7062 is used for generating a first digital value FDV according to the first reference current IREF1.The adjuster 706 obtains a second digital value SDV corresponding to the first digital value FDV according to the first digital value FDV and the lookup table 7064, wherein the lookup table 7064 is used for storing the second digital value SDV corresponding to the first digital value FDV. The digital-to-analog converter 7066 is used for generating the adjustment voltage VAD according to the second digital value SDV corresponding to the first digital value FDV, wherein a current IRP shown in FIG. 8 corresponds to a first predetermined current IP1 (shown in FIG. 9). As shown in FIG. 7, the lookup table 7064 can be a lookup table built in a read-only memory. But, the present invention is not limited to the lookup table 7064 being a lookup table built in a read-only memory. Therefore, as shown in FIG. 9, the control circuit 700 can generate the target voltage VLED according to the adjustment voltage VAD. In addition, subsequent operational principles of the control circuit 700 are the same as those of the control circuit 100, so further description thereof is omitted for simplicity.

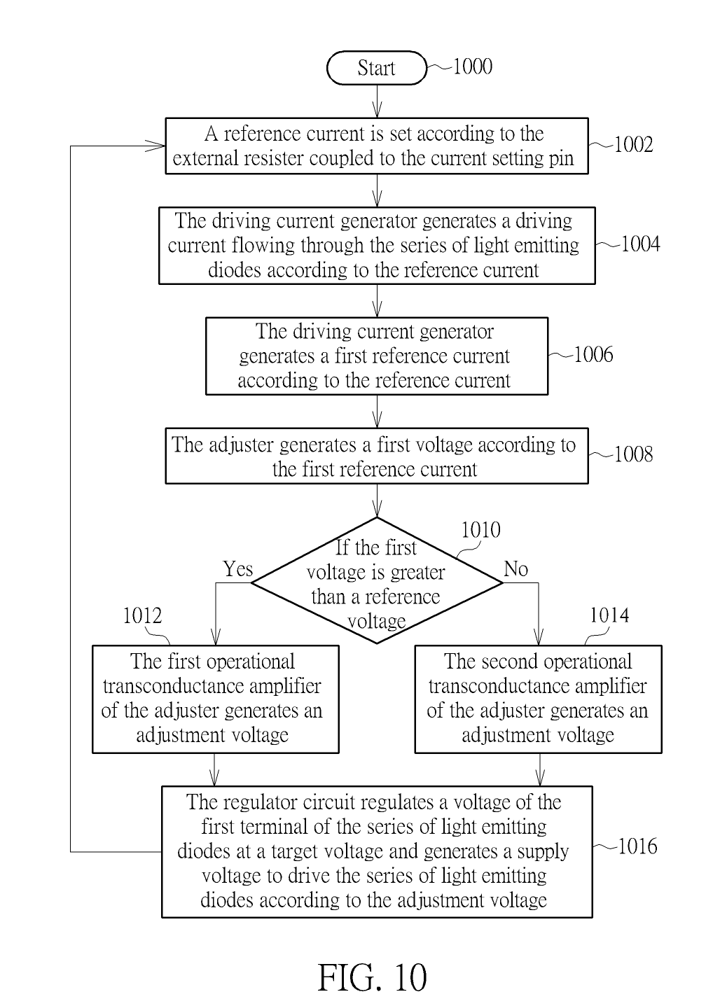

Please refer to FIG. 1, FIG. 2, FIG. 3, and FIG. 10. FIG. 10 is a flowchart illustrating an operation method of a control circuit of light emitting diodes according to another embodiment. The method in FIG. 10 is illustrated using the control circuit 100 in FIG. 1. Detailed steps are as follows:

Step 1000: Start.

Step 1002: A reference current IREF is set according to the external resister 110 coupled to the current setting pin 102.

Step 1004: The driving current generator 108 generates a driving current ILED flowing through the series of light emitting diodes 112 according to the reference current IREF.

Step 1006: The driving current generator 108 generates a first reference current IREF1 according to the reference current IREF.

Step 1008: The adjuster 106 generates a first voltage V1 according to the first reference current IREF1.

Step 1010: If the first voltage V1 is greater than a reference voltage VREF; if yes, go to Step 1012; if no, go to Step 1014.

Step 1012: The first operational transconductance amplifier 1064 of the adjuster 106 generates an adjustment voltage VAD, go to Step 1016.

Step 1014: The second operational transconductance amplifier 1066 of the adjuster 106 generates an adjustment voltage VAD, go to Step 1016.

Step 1016: The regulator circuit 104 regulates a voltage of the first terminal of the series of light emitting diodes 112 at a target voltage VLED and generates a supply voltage VOUT to drive the series of light emitting diodes 112 according to the adjustment voltage VAD, go to Step 1002.

In Step 1004, the driving current generator 108 generates the driving current ILED flowing through the series of light emitting diodes 112 according to the reference current IREF, the transistors 1082, 1084, and the amplifier 1086. In Step 1006, the driving current generator 108 generates the first reference current IREF1 proportion to the reference current IREF through the transistor 1088 of the driving current generator 108. In Step 1008, as shown in FIG. 3, the first resister 1062 of the adjuster 106 generates the first voltage V1 according to the first reference current IREF1. In Step 1012, as shown in FIG. 1 and FIG. 3, when the first voltage V1 is greater than the reference voltage VREF, the first operational transconductance amplifier 1064 of the adjuster 106 generates the adjustment voltage VAD according to equation (1), wherein the reference voltage VREF corresponds to the first predetermined current IP1. In Step 1014, as shown in FIG. 1 and FIG. 3, when the first voltage V1 is less than the reference voltage VREF, the second operational transconductance amplifier 1066 of the adjuster 106 generates the adjustment voltage VAD according to equation (2). In Step 1016, the compensator 1042 of the regulator circuit 104 can generate a compensation value VC according to the adjustment voltage VAD and a feedback voltage VFB, wherein the feedback voltage VFB corresponds to the target voltage VLED, and the target voltage VLED is inputted to the regulator circuit 104 through the feedback pin 114. The comparator 1044 of the regulator circuit 104 can generate a comparison result VR according to the compensation value VC and a dimming signal. The comparison result VR controls the switch 1050 of the boost circuit 118 through the logic circuit 1046, the gate control circuit 1048, and the gate pin 116. Therefore, in Step 1016, the regulator circuit 104 can regulate the voltage of the first terminal of the series of light emitting diodes 112 at the target voltage VLED and generate the supply voltage VOUT to drive the series of light emitting diodes 112 through the above mentioned loop mechanism, wherein the target voltage VLED is equal to the supply voltage VOUT minus a voltage drop of the series of light emitting diodes 112.

As shown in FIG. 1 and FIG. 3, because the adjustment voltage VAD generated by the adjuster 106 is changed with the first voltage V1, the adjustment voltage VAD is changed with the driving current ILED. Therefore, the control circuit 100 can generate the target voltage VLED changed with the driving current ILED through the adjustment voltage VAD changed with the driving current ILED. As shown in FIG. 2, when the driving current ILED is greater than the first predetermined current (e.g. 100 mA) IP1, the regulator circuit 104 can control the target voltage VLED to be increased with increase of the driving current ILED, and when the driving current ILED is less than the first predetermined current IP1, the regulator circuit 104 can control the target voltage VLED to be increased with decrease of the driving current ILED.

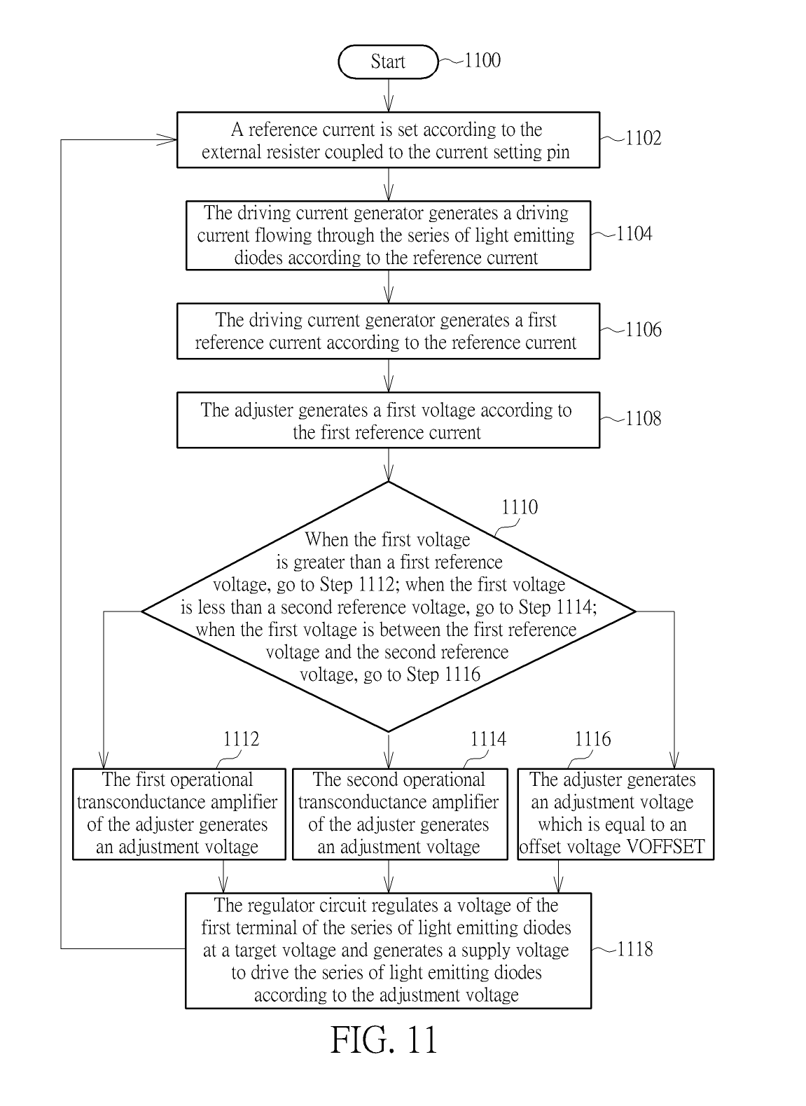

Please refer to FIG. 4, FIG. 5, FIG. 6, and FIG. 11. FIG. 11 is a flowchart illustrating an operation method of a control circuit of light emitting diodes according to another embodiment. The method in FIG. 11 is illustrated using the control circuit 400 in FIG. 4. Detailed steps are as follows:

Step 1100: Start.

Step 1102: A reference current IREF is set according to the external resister 110 coupled to the current setting pin 102.

Step 1104: The driving current generator 108 generates a driving current ILED flowing through the series of light emitting diodes 112 according to the reference current IREF.

Step 1106: The driving current generator 108 generates a first reference current IREF1 according to the reference current IREF.

Step 1108: The adjuster 406 generates a first voltage V1 according to the first reference current IREF1.

Step 1110: When the first voltage V1 is greater than a first reference voltage VREF1, go to Step 1112; when the first voltage V1 is less than a second reference voltage VREF2, go to Step 1114; when the first voltage V1 is between the first reference voltage VREF1 and the second reference voltage VREF2, go to Step 1116.

Step 1112: The first operational transconductance amplifier 4064 of the adjuster 406 generates an adjustment voltage VAD, go to Step 1118.

Step 1114: The second operational transconductance amplifier 4066 of the adjuster 406 generates an adjustment voltage VAD, go to Step 1118.

Step 1116: The adjuster 406 generates an adjustment voltage VAD which is equal to an offset voltage VOFFSET, go to Step 1118.

Step 1118: The regulator circuit 104 regulates a voltage of the first terminal of the series of light emitting diodes 112 at a target voltage VLED and generates a supply voltage VOUT to drive the series of light emitting diodes 112 according to the adjustment voltage VAD, go to Step 1102.

In Step 1110, as shown in FIG. 5 and FIG. 6, the first reference voltage VREF1 corresponds to the second predetermined current IP2, and the second reference voltage VREF2 corresponds to the first predetermined current IP1. In Step 1112, as shown in FIG. 4 and FIG. 5, when the first voltage V1 is greater than the first reference voltage VREF1, the first operational transconductance amplifier 4064 of the adjuster 406 generates the adjustment voltage VAD according to equation (3). In Step 1114, as shown in FIG. 4 and FIG. 5, when the first voltage V1 is less than the second reference voltage VREF2, the second operational transconductance amplifier 4066 of the adjuster 406 generates the adjustment voltage VAD according to equation (4). In Step 1116, as shown in FIG. 4, FIG. 5, equation (3), and equation (4), when the first voltage V1 is between the first reference voltage VREF1 and the second reference voltage VREF2, the adjustment voltage VAD is equal to the offset voltage VOFFSET. Therefore, as shown in FIG. 4 and FIG. 5, because the adjustment voltage VAD generated by the adjuster 406 is changed with the first voltage V1 (corresponding to the first reference current IREF1), the adjustment voltage VAD is changed with the driving current ILED (corresponding to the reference current IREF). In addition, because the regulator circuit 104 can generate the supply voltage VOUT according to the adjustment voltage VAD, and the target voltage VLED is equal to the supply voltage VOUT minus a voltage drop of the series of light emitting diodes 112. Therefore, the control circuit 400 can generate the target voltage VLED changed with the driving current ILED through the adjustment voltage VAD changed with the driving current ILED. That is to say, as shown in FIG. 6, when the driving current ILED is greater than the second predetermined current IP2, the target voltage VLED is increased with increase of the driving current ILED; and when the driving current ILED is less than the first predetermined current IP1, the target voltage VLED is increased with decrease of the driving current ILED.

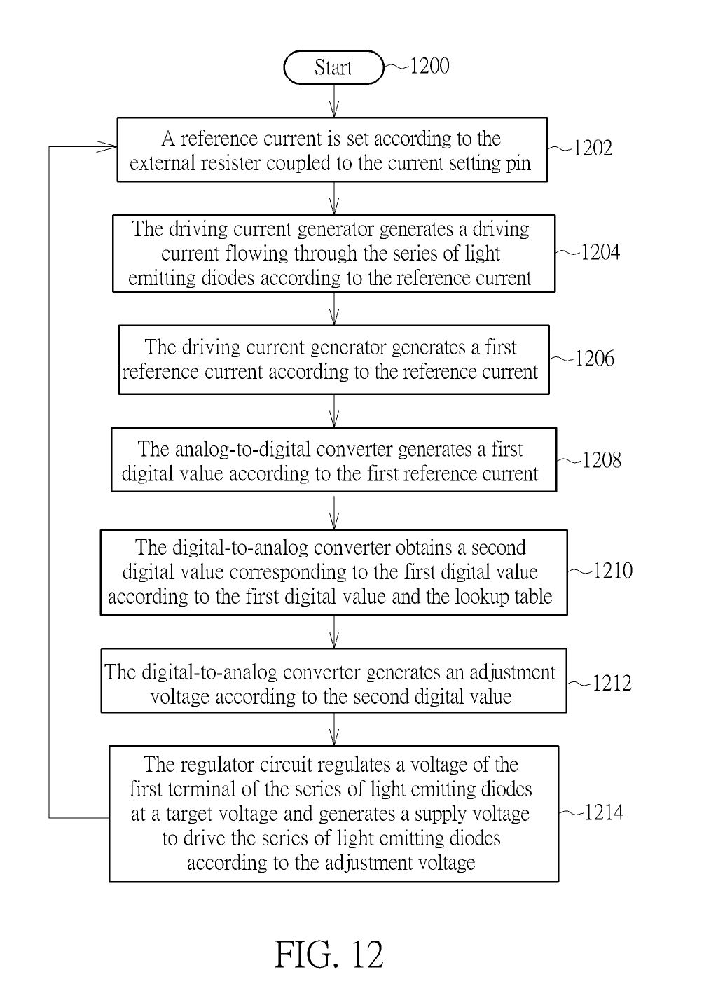

Please refer to FIG. 7, FIG. 8, FIG. 9, and FIG. 12. FIG. 12 is a flowchart illustrating an operation method of a control circuit of light emitting diodes according to another embodiment. The method in FIG. 12 is illustrated using the control circuit 700 in FIG. 7. Detailed steps are as follows:

Step 1200: Start.

Step 1202: A reference current IREF is set according to the external resister 110 coupled to the current setting pin 102.

Step 1204: The driving current generator 108 generates a driving current ILED flowing through the series of light emitting diodes 112 according to the reference current IREF.

Step 1206: The driving current generator 108 generates a first reference current IREF1 according to the reference current IREF.

Step 1208: The analog-to-digital converter 7062 generates a first digital value FDV according to the first reference current IREF1.

Step 1210: The digital-to-analog converter 7066 obtains a second digital value SDV corresponding to the first digital value FDV according to the first digital value FDV and the lookup table 7064.

Step 1212: The digital-to-analog converter 7066 generates an adjustment voltage VAD according to the second digital value SDV.

Step 1214: The regulator circuit 104 regulates a voltage of the first terminal of the series of light emitting diodes 112 at a target voltage VLED and generates a supply voltage VOUT to drive the series of light emitting diodes 112 according to the adjustment voltage VAD, go to Step 1202.

A difference between the embodiment in FIG. 12 and the embodiment in FIG. 10 is that in Step 1208, the analog-to-digital converter 7062 is used for generating the first digital value FDV according to the first reference current IREF1; in Step 1210, the digital-to-analog converter 7066 obtains the second digital value SDV corresponding to the first digital value FDV according to the first digital value FDV and the lookup table 7064, wherein the lookup table 7064 is used for storing the second digital value SDV, and the lookup table 7064 can be a lookup table built in a read-only memory (but, the present invention is not limited to the lookup table 7064 being a lookup table built in a read-only memory; and in Step 1212, the digital-to-analog converter 7066 generates the adjustment voltage VAD according to the second digital value SDV. Therefore, as shown in FIG. 7, FIG. 8, and FIG. 9, the control circuit 700 can generate the target voltage VLED according to the adjustment voltage VAD. In addition, subsequent operational principles of the embodiment in FIG. 12 are the same as those of the embodiment in FIG. 10, so further description thereof is omitted for simplicity.

To sum up, the control circuit of light emitting diodes and the operation method of the control circuit of light emitting diodes utilize the adjuster to generate an adjustment voltage changed with a driving current according to a reference current. Then, the regulator circuit can regulate a voltage of the first terminal of the series of light emitting diodes at a target voltage according to the adjustment voltage changed with the driving current. Therefore, when the driving current is greater than a predetermined current, the regulator circuit can control the target voltage to be increased with increase of the driving current, and when the driving current is less than the predetermined current, the regulator circuit can control the target voltage to be increased with decrease of the driving current. Thus, the present invention has advantages as follows: first, because when the driving current is less than the predetermined current, the target voltage is increased with decrease of the driving current, the present invention can reduce an error of the target voltage; second, because when the driving current is less than the predetermined current, the target voltage is increased with decrease of the driving current, the present invention not only can increase a signal-to-noise ratio of the target voltage, but can also overcome errors within the regulator circuit simultaneously; third, because when the driving current is less than the predetermined current, the target voltage is increased with decrease of the driving current, an offset of the driving current is decreased, resulting in accuracy of the driving current being higher; fourth, because the adjuster only increases a few elements to the control circuit, cost of the present invention is only little increased; and fifth, the present invention can increase power efficiency and decrease unnecessary heat.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit of light emitting diodes, wherein the control circuit is used for driving at least one series of light emitting diodes, the control circuit comprising:
a current setting pin, wherein a reference current flows through the current setting pin;
a driving current generator for generating a driving current flowing through the series of light emitting diodes according to the reference current;
an adjuster for generating an adjustment voltage according to the reference current; and
a regulator circuit for regulating a voltage of a first terminal of the series of light emitting diodes at a target voltage and generating a supply voltage to drive the series of light emitting diodes according to the adjustment voltage;
wherein when the driving current is less than a first predetermined current, the target voltage is increased with decrease of the driving current.

2. The control circuit of claim 1, wherein the current setting pin is coupled to an external resister, and the external resister is used for setting the reference current.

3. The control circuit of claim 1, wherein the adjuster generating the adjustment voltage according to the reference current is the adjuster generating the adjustment voltage according to a first reference current which is proportion to the reference current.

4. The control circuit of claim 3, wherein when the driving current is greater than the first predetermined current, the target voltage is increased with increase of the driving current.

5. The control circuit of claim 4, wherein the adjuster comprises:
a first resister for generating a first voltage according to the first reference current;
a first operational transconductance amplifier (OTA), wherein a positive input terminal and a negative input terminal of the first operational transconductance amplifier are coupled to the first resister and a reference voltage, respectively;
a second operational transconductance amplifier, wherein a positive input terminal and a negative input terminal of the second operational transconductance amplifier are coupled to the reference voltage and the first resister, respectively; and
a second resister coupled to the first operational transconductance amplifier, the second operational transconductance amplifier, and an offset voltage;
wherein when the first voltage is greater than the reference voltage, the first operational transconductance amplifier generates the adjustment voltage; and when the first voltage is less than the reference voltage, the second operational transconductance amplifier generates the adjustment voltage.

6. The control circuit of claim 5, wherein when the first voltage is greater than the reference voltage, the adjustment voltage is generated according to the following equation:
VAD=R2×(V1−VREF)×G1+VOFFSET;
wherein:
VAD is the adjustment voltage;
R2 is a resistance of the second resister;
V1 is the first voltage;
VREF is the reference voltage;
G1 is a transconductance of the first operational transconductance amplifier; and
VOFFSET is the offset voltage.

7. The control circuit of claim 5, wherein when the first voltage is less than the reference voltage, the adjustment voltage is generated according to the following equation:
VAD=R2×(VREF−V1)×G2+VOFFSET;
wherein:
VAD is the adjustment voltage;
R2 is a resistance of the second resister;
V1 is the first voltage;
VREF is the reference voltage;
G2 is a transconductance of the second operational transconductance amplifier; and
VOFFSET is the offset voltage.

8. The control circuit of claim 3, wherein when the driving current is greater than a second predetermined current, the target voltage is increased with increase of the driving current.

9. The control circuit of claim 8, wherein the adjuster comprises:
a first resister for generating a first voltage according to the first reference current;
a first operational transconductance amplifier, wherein a positive input terminal and a negative input terminal of the first operational transconductance amplifier are coupled to the first resister and a first reference voltage, respectively;
a second operational transconductance amplifier, wherein a positive input terminal and a negative input terminal of the second operational transconductance amplifier are coupled to a second reference voltage and the first resister, respectively; and
a second resister coupled to the first operational transconductance amplifier, the second operational transconductance amplifier, and an offset voltage;
wherein when the first voltage is greater than the first reference voltage, the first operational transconductance amplifier generates the adjustment voltage; when the first voltage is less than the second reference voltage, the second operational transconductance amplifier generates the adjustment voltage; and when the first voltage is between the first reference voltage and the second reference voltage, the adjustment voltage is equal to the offset voltage.

10. The control circuit of claim 9, wherein when the first voltage is greater than the first reference voltage, the adjustment voltage is generated according to the following equation:
VAD=R2×(VV1−VREF1)×G1+VOFFSET;
wherein:
VAD is the adjustment voltage;
R2 is a resistance of the second resister;
V1 is the first voltage;
VREF1 is the first reference voltage;
G1 is a transconductance of the first operational transconductance amplifier; and
VOFFSET is the offset voltage.

11. The control circuit of claim 9, wherein when the first voltage is less than the second reference voltage, the adjustment voltage is generated according to the following equation:
VAD=R2×(VREF2−V1)×G2+VOFFSET ;
wherein:
VAD is the adjustment voltage;
R2 is a resistance of the second resister;
V1 is the first voltage;
VREF2 is the second reference voltage;
G2 is a transconductance of the second operational transconductance amplifier; and
VOFFSET is the offset voltage.

12. The control circuit of claim 3, wherein the adjuster comprises:
an analog-to-digital converter for generating a first digital value according to the first reference current;
a lookup table for storing a second digital value corresponding to the first digital value; and
a digital-to-analog converter for generating the adjustment voltage according to a corresponding second digital value.

13. The control circuit of claim 1, wherein the regulator circuit generates the supply voltage according to the adjustment voltage.

14. The control circuit of claim 1, wherein the target voltage is equal to the supply voltage minus a voltage drop of the series of light emitting diodes.

15. An operation method of a control circuit of light emitting diodes, wherein the control circuit comprises a current setting pin, an adjuster, a regulator circuit, and a driving current generator, and the control circuit is used for driving at least one series of light emitting diodes, the operation method comprising:
setting a reference current according to an external resister coupled to the current setting pin, wherein the reference current flows through the current setting pin;
the driving current generator generating a driving current flowing through the series of light emitting diodes according to the reference current;
the adjuster generating an adjustment voltage according to the reference current; and
the regulator circuit regulating a voltage of a first terminal of the series of light emitting diodes at a target voltage and generating a supply voltage to drive the series of light emitting diodes according to the adjustment voltage;
wherein when the driving current is less than a first predetermined current, the target voltage is increased with decrease of the driving current.

16. The operation method of claim 15, wherein the adjuster generating the adjustment voltage according to the reference current is the adjuster generating the adjustment voltage according to a first reference current which is proportion to the reference current.

17. The operation method of claim 16, wherein when the driving current is greater than the first predetermined current, the target voltage is increased with increase of the driving current.

18. The operation method of claim 17, wherein the adjuster generating the adjustment voltage according to the first reference current comprises:
generating a first voltage according to the first reference current; and
a first operational transconductance amplifier of the adjuster generating the adjustment voltage when the first voltage is greater than the reference voltage.

19. The operation method of claim 18, wherein when the first voltage is greater than the reference voltage, the adjustment voltage is generated according to the following equation:
VAD=R2×(V1−VREF)×G1+VOFFSET;
wherein:
VAD is the adjustment voltage;
R2 is a resistance of a second resister of the adjuster;
V1 is the first voltage;
VREF is the reference voltage inputted to the first operational transconductance amplifier;
G1 is a transconductance of the first operational transconductance amplifier; and
VOFFSET is an offset voltage.

20. The operation method of claim 17, wherein the adjuster generating the adjustment voltage according to the first reference current comprises:
generating a first voltage according to the first reference current; and
a second operational transconductance amplifier of the adjuster generating the adjustment voltage when the first voltage is less than the reference voltage.

21. The operation method of claim 20, wherein when the first voltage is less than the reference voltage, the adjustment voltage is generated according to the following equation:
VAD=R2×(VREF−V1)×G2+VOFFSET;
wherein:
VAD is the adjustment voltage;
R2 is a resistance of a second resister of the adjuster;
V1 is the first voltage;
VREF is a reference voltage inputted to the second operational transconductance amplifier;
G2 is a transconductance of the second operational transconductance amplifier; and
VOFFSET is an offset voltage.

22. The operation method of claim 16, wherein when the driving current is greater than a second predetermined current, the target voltage is increased with increase of the driving current.

23. The operation method of claim 22, wherein the adjuster generating the adjustment voltage according to the first reference current comprises:
generating a first voltage according to the first reference current; and
a first operational transconductance amplifier of the adjuster generating the adjustment voltage when the first voltage is greater than a first reference voltage.

24. The operation method of claim 23, wherein when the first voltage is greater than the first reference voltage, the adjustment voltage is generated according to the following equation:
VAD=R2×(V1−VREF1)×G1+VOFFSET;
wherein:
VAD is the adjustment voltage;
R2 is a resistance of a second resister of the adjuster;
V1 is the first voltage;
VREF1 is the first reference voltage inputted to the first operational transconductance amplifier;
G1 is a transconductance of the first operational transconductance amplifier; and
VOFFSET is an offset voltage.

25. The operation method of claim 22, wherein the adjuster generating the adjustment voltage according to the first reference current comprises:
generating a first voltage according to the first reference current; and
a second operational transconductance amplifier of the adjuster generating the adjustment voltage when the first voltage is less than a second reference voltage.

26. The operation method of claim 25, wherein when the first voltage is less than the second reference voltage, the adjustment voltage is generated according to the following equation:
VAD=R2×(VREF2−V1)×G2+VOFFSET;
wherein:
VAD is the adjustment voltage;
R2 is a resistance of a second resister of the adjuster;
V1 is the first voltage;
VREF2 is the second reference voltage inputted to the second operational transconductance amplifier;
G2 is a transconductance of the second operational transconductance amplifier; and
VOFFSET is an offset voltage.

27. The operation method of claim 22, wherein the adjuster generating the adjustment voltage according to the first reference current comprises:
generating a first voltage according to the first reference current; and
the adjustment voltage being equal to an offset voltage when the first voltage is between the first reference voltage and the second reference voltage.

28. The operation method of claim 17, wherein the adjuster generating the adjustment voltage according to the first reference current comprises:
generating a first digital value according to the first reference current;
obtaining a corresponding second digital value according to the first digital value and a lookup table; and
generating the adjustment voltage according to the corresponding second digital value.

29. The operation method of claim 15, wherein the target voltage is equal to the supply voltage minus a voltage drop of the series of light emitting diodes.
